(19) United States
(12) Patent Application Publication
(10) Pub. No.: US 2026/0246822 A1
(43) Pub. Date: Aug. 20, 2026

(54) SYSTEMS AND METHODS FOR STREAMING CONTENT

(71) Applicant: NEVAYA LIMITED, Swindon (GB)

(72) Inventor: Ben Clifford, Swindon (GB)

(21) Appl. No.: 19/474,714

(22) PCT Filed: Apr. 13, 2023
(86) PCT No.: PCT/GB2023/050992

§ 371 Date: Oct. 12, 2025

(51) Int. Cl. H04L 65/1094

(52) U.S. Cl. CPC H04L 65/1094

(57) ABSTRACT

A content streaming system for streaming audio and video data to a television within a room in a multi-room accommodation, such as a hotel. The system including a multi-room accommodation router connect to an on-site local area network, the router configured to monitor, interact with and forward data packets, and a an off-site media streaming unit including media streaming devices that encode and transmit audio and video data and a cloud server disposed off-site that includes a virtual multi-room accommodation site container communicatively connected to the router and to the media streaming unit. The system is configured to monitor data packets from the on-site local area network for media streaming device connection requests from a guest device connected to the on-site local area network, and communicate a device description packet for each media streaming device and a device notification packet from the cloud server to the guest device.

### CROSS REFERENCE TO RELATED APPLICATIONS

This application is a national stage entry application of international patent application No. PCT/GB2023/050992, having an international filing date of Apr. 13, 2023; the entirety of which is hereby incorporated by reference herein.

### FIELD OF THE INVENTION

The present invention relates to a system for streaming audio and video content to an in-room television or in-room display within a multi-room accommodation and particularly but not exclusively to a system for streaming audio and video data to an in-room television or in-room display within a multi-room accommodation by pairing a guest device connected to an accommodation subnetwork with a remote media streaming device on a separate subnet.

### BACKGROUND OF THE INVENTION

Multi-room accommodations, especially hotels, are known to provide In-Room-Entertainment services on a television or other display capable of displaying video content inside each room for their guests, tenants or residents. For example, the In-Room-Entertainment may provide entertainment content, such as movies or TV shows, or local information.

Traditionally the televisions are connected to an accommodation wide audio-visual system which typically comprises a central stack or server within the multi-rom accommodation. The central stack or server is used so that each room and television does not require its own set top box with an audio-visual signal decoder to allow viewing of content. The central stack or server provides a way to control, organise and distribute content to each television at the request of the guest, resident or tenant. Typically, the guest, tenant or resident would have access to various channels with set content schedules and pay-per-view movie channels through the accommodation wide audio-visual system.

With the advent of high-speed internet and streaming services, users have become accustomed to easy and convenient access to large volumes of media content through the service provided by the streaming service providers. Typically, the streaming service will make suggestions as to what they believe the user of the profile will like based on the usage record and provide a convenient solution to pick up where the user left off. This individualised service has resulted in hotel guests wanting to watch the content available through their accounts on the streaming services.

Guests, tenants or residents will typically connect to the accommodation's wireless network to access their streaming service account through the internet to avoid using mobile data. In such cases the viewing experience is substandard as the wireless network can be lossy and slow resulting in low quality video which may need to be buffered. Additionally, the user will likely access their accounts through personal devices such as smart phones, tablet computers, laptops or similar, to maintain account security, however, this results in a reduced viewing experience since the content is displayed on a small screen. Some users have security concern about using networks with multiple devices of unknown users.

To address this issue multi-room accommodations have started to include streaming devices connected to, or incorporated in, the TV within the room to allow the guest, tenant or resident to mirror their device display onto the TV or stream content through controlling applications running on their device which is paired to the streaming device. Example of a streaming device typically connected to the TV is a Chromecast (RTM).

FIG. 1 shows a typical version of an existing system 100 using streaming and/or casting devices within a hotel.

The guest will connect to the device over the hotel's wireless network 102, preferably a dedicated streaming wireless local area network (WLAN) for in-room entertainment services. A plurality of streaming devices 104, such as Chromecasts, are connected to the wireless network 102. The network 104 being connected to an on-site proxy server 106, i.e. a server provided within the hotel's premises. The proxy server 106 being connected to a High Speed Internet Access Local Area Network (HSIA LAN) 108 with a gateway 110 to the internet.

The implementation shown in FIG. 1 allows the hotels to provide an additional layer of security as well as centralised control, including the ability to provide additional services and promotions, but it can be expensive to implement and requires high levels of maintenance, is inefficient and is difficult to maintain. For example, each TV requires a dedicated casting device, either as an additional dongle or integrated component, which increases costs, and must maintain a connection to the wireless local area network connected to the proxy server so requires suitable wireless signal strength.

Additionally, there is a significant power consumption on-site from these types of implementations given the number of devices. This consumption is exacerbated when there are multiple hotels, for example, a chain of hotels using the same system implementation. Similar problems are present in other types of multi-room accommodations, such as student accommodations, serviced apartments, senior living multi-room accommodation etc.

It is an object of the present invention to reduce or substantially obviate the aforementioned problems.

### STATEMENT OF INVENTION

According to the present invention there is provided a content streaming system for streaming audio and video data to a television within a multi-room accommodation, the system comprising: a multi-room accommodation router being operably configured to connect to an on-site local area network at a multi-room accommodation site, the multi-room accommodation router being configured to monitor, interact with and forward data packets on the local area network of said multi-room accommodation; a media streaming unit disposed off-site with respect to the multi-room accommodation, the media streaming unit including a plurality of media streaming devices, each media streaming device being operable to encode and transmit audio and video data to the television within the multi-room accommodation; and a cloud server disposed off-site with respect to the multi-room accommodation, the cloud server comprising a virtual multi-room accommodation site container communicatively connected to the multi-room accommodation router and to the media streaming unit; wherein the system is configured to: monitor data packets from the on-site local area network of said multi-room accommodation for media streaming device connection requests from a guest device connected to the on-site local area network of said multi-room accommodation; communicate, in response to media streaming device connection request, a notification packet for the or each media streaming device from the cloud server to the guest device connected to the on-site local area network through the multi-room accommodation router, wherein the notification packet comprises at least some authentic device description details and at least some modified data configured to show that the or each media streaming device is part of the on-site local area network at the multi-room accommodation; establish connection between the guest device on the on-site local area network and one of the media streaming devices in the off-site media streaming unit through the cloud server; receive instructions for the media streaming device from the guest device at the cloud server; and generate a stream of audio and video data at media streaming device based on the received instructions for display at a television or other displace in the multi-room accommodation.

In another aspect of the present invention a method of streaming audio and video data to a television within a multi-room accommodation is provided, the method comprising the steps of: providing a pool of media streaming devices; monitoring, by a multi-room accommodation router connected to an on-site local area network at the multi-room accommodation, data packet from an on-site local area network within said multi-room accommodation for a media streaming device connection request from a guest device connected to the on-site local area network; communicating, in response to the media streaming device connection request, a notification packet for the or each media streaming device from an off-site cloud server managing the pool of media streaming devices, wherein the notification packet comprises at least some authentic device description details and at least some modified data configured to show that the or each media streaming device is part of the on-site local area network at the multi-room accommodation; establishing a connection between the guest device and one of the media streaming devices in the pool of media streaming devices; receiving instructions for the media streaming device from the guest device at the cloud server; and generating a stream of audio and video data at the media streaming device based on the received instructions for display at the television or display in the multi-room accommodation.

The provisions of the plurality or pool of media streaming devices in a remote media streaming unit provides a way of streaming audio and video data to multiple televisions within a multi-room accommodation such as a hotel, or multiple televisions between different multi-room establishments, such as multiple hotels. This arrangement maximises the use of media streaming devices since one remote media streaming device may be used to stream audio and video data to different televisions at different times which reduces the overall number of media streaming devices needed to cater of the same number of televisions, this is especially beneficial when the system includes a plurality of multi-room accommodations in different times zones. Centralising the media streaming devices in a remote location reduces energy costs for the multi-room accommodation, it also simplifies the on-site networks within the multi-room accommodation making for easier maintenance.

By providing an intermediary which can monitor and modify data packets it is possible to convince guest devices connected to the on-site local area network that a media streaming device is present on the same local area network. It also provides a means to control operation of the media streaming unit to ensure optimal usage of each media streaming device.

The architecture used for the systems and method removes the constraints of the on-site network design and abstracts this so that media streaming devices may be re-used over and over again for different rooms.

The term multi-room accommodation may be considered a multi-room establishment which provides accommodation for multiple people separately. In some embodiments, it may be an individual room, such as a hotel room, or it may be a set of rooms forming a single unit such as a hotel suite or serviced apartments. Typically, the multi-room accommodation will include a number of rooms or units with each room or unit providing accommodation.

A guest device may be considered a device capable of connecting to the local area network, such as a smart phone, tablet, laptop or similar. The guest may be a guest of a hotel, a resident of a student accommodation, a resident of a senior living establishment or similar.

The multi-room accommodation may be a hotel. In such cases, features associated with the multi-room accommodation may be features associated with the hotel, for example, the multi-room accommodation router may be a hotel router, the virtual multi-room accommodation site container may be a virtual hotel site container etc.

The multi-room accommodation may be a plurality of serviced apartments. The multi-room accommodation may be student accommodation. The multi-room accommodation may be senior living accommodation. In such cases, in a similar fashion to above, features associated with the multi-room accommodation may be features associated with the serviced apartments, features associated with student accommodation etc.

The multi-room accommodation may comprise a plurality of televisions or similar displays, preferably a plurality in-room televisions or in-room displays. That is to say that a television or similar display is provided in each room of the multi-room accommodation.

Establishing a connection may be understood to mean pairing. Preferably the established connection, or pairing, is temporary. The system may be configured to monitor usage by a guest device, and after a predetermined time of inactivity the guest device is disconnected from the established connection, i.e. unpaired.

The virtual multi-room accommodation site container may be configured to perform packet filtering of the data packets from the on-site local area network of said multi-room accommodation. The virtual multi-room accommodation site container may be configured to perform packet manipulation of the data packets on the on-site local area network of said multi-room accommodation.

The system may be further configured to emulate the received instructions sent from the guest device. The emulated instructions may be for the media streaming device of the established connection.

The system may be further configured to pass through the received instructions sent from the guest device to the media streaming device of the established connection.

The content streaming system may be configured for use with a plurality of multi-room accommodations, for example a plurality of hotels. In some embodiments, the plurality of multi-room accommodations may be the same type of accommodation for example a hotel. In some embodiments, the plurality of multi-room accommodations may be mixed, for example hotels and student accommodation etc. A plurality of multi-room accommodation routers may be provided, each multi-room accommodation router being operably configured to connect to an on-site local area network at one multi-room accommodation of a plurality of multi-room accommodations. The cloud server may comprise a plurality of virtual multi-room accommodation site containers. Each virtual multi-room accommodation site container may correspond to one multi-room accommodation of the plurality of multi-room accommodations and be connected to the corresponding multi-room accommodation router.

The system may be configured so that one media streaming unit is connected to a plurality of virtual multi-room accommodation site containers. That is to say that a single media streaming unit may be accessible to each virtual multi-room accommodation site container of the plurality of virtual multi-room accommodation site containers.

The media streaming unit may support a large number of media streaming devices in the pool. The number of media streaming devices in the pool may be hundreds of devices, for example up to 300 or at least 300 media streaming devices. A plurality of media streaming units may be provided, with each media streaming unit providing a plurality of media streaming units in a pool. In such cases, there are multiple pools of media streaming devices.

The cloud server, when a virtualised cloud server, may support a number of virtual site containers. For example, up to 30 or more than 30 virtual multi-room accommodation site containers. In other embodiments, multiple virtualised cloud servers may be provided each supporting a plurality of virtual site containers.

A container may be a virtualised machine, preferably only virtualised to the software layers and above, more preferably the operating system and above. A container may be lightweight with software packages that comprises all dependencies to execute a software application. The dependencies may include system libraries, code packages, and operating system level applications among other things. The dependencies of the container may exist in stack levels that are higher than the operating system.

The cloud server may be a virtualised server mounted within a data centre server.

The cloud server may comprise a pool manager. The pool manager may be a virtual machine or the virtual server. A software-defined network (SDN) may be defined and maintained by the cloud server, preferably the virtual cloud server, more preferably the pool manager.

Guest device authentication may be provided. Preferably the cloud server may be configured to perform guest device authentication. More preferably, the pool manager may be configured to perform guest device authentication.

The cloud server may comprise a cache for storing information related to each media streaming device in the pool of media streaming devices. The stored information may comprise the device description details for each media streaming device of the plurality of media streaming devices. The device description details may comprise the location of each device description details. The location may be modified so that the media streaming device appears to be part of the on-site local area network of the multi-room accommodation. The cache may be accessible by the or each virtual multi-room accommodation site container.

A virtual private network (VPN) may be provided. The virtual private network may comprise the guest device, multi-room accommodation router, the cloud server and/or the media streaming unit. The VPN may also comprise all virtualised machines or virtualised computers, such as the pool manager and/or the virtual multi-room accommodation site container.

A plurality of televisions or displays, preferably a plurality of in-room televisions or a plurality of in-room displays may be provided. That is to say that each room within the multi-room accommodation may each have an in-room television or in-room display.

A television identification code may be provided. A display identification code may be provided. The identification code may be for disposal to the television or display in the multi-room accommodation. The identification code may comprise a unique ID and a security key for uniquely identifying the television or display to the system. The identification code may be a visual identification code, such as a Quick Read (QR) code. When there are a plurality of multi-room accommodations each with a plurality of rooms, each television in each multi-room accommodation will also be uniquely identifiable.

The cloud server may be configured to receive a message containing the unique ID and the security key. The cloud server may be configured to receive guest device details. The cloud server may be configured to associate the guest device and the television or display when it has received the unique ID, the security key and the guest device details. The cloud server may initially reserve one media streaming device or a set of media streaming devices for possibly establishing connection. Said media streaming devices may not have an established connection to another guest device on the same on-site local area network or another on-site local area network of a different multi-room accommodation.

The guest device may be provided with details of a single media streaming device or a set of media streaming devices. The set of media streaming devices may be a selection of media streaming devices which do not have a current established connection.

The system may monitor usage statistics of the plurality of media streaming devices in the media streaming unit. The system may optimise the media streaming unit, for example, the power consumption of the media streaming unit may be optimised based on the monitored usage statistics. In some embodiments, such as those where there is a plurality of media streaming units, the system may minimise stream latency between a specific media streaming unit and a specific multi-room accommodation. In other embodiments, the system may minimise stream latency between specific media streaming devices in the pool and a specific multi-room accommodation. Usage statistics may comprise stream latency information.

The system may determine which is the most optimal media streaming device to use for a given multi-room accommodation based on the usage statistics. The optimal media streaming device may be determined based on reduced latency.

The system may also monitor health of the media streaming devices within the media streaming unit.

A stored multi-room accommodation configuration may be provided. The stored multi-room accommodation configuration may comprise a graphical user interface for the multi-room accommodation. The virtual multi-room accommodation site container may comprise the stored multi-room accommodation configuration. The stored multi-room accommodation configuration may be loaded to the media streaming device prior to use at the multi-room accommodation. The stored multi-room accommodation configuration may be unloaded after use. The stored multi-room accommodation configuration may be loaded prior to or during the process of establishing the connection.

The media streaming devices may also be media casting devices.

The media streaming devices may be known media streaming devices, such as Chromecasts (RTM) or similar. Preferably, the media streaming devices are all Chromecasts (RTM).

The media streaming device may stream audio and video data through a secured content delivery network (CDN) network.

The media streaming device may stream audio and video data through the virtual private network.

The media streaming device may encode the audio and video data using known video and audio encoding techniques. The media streaming device streams audio and video data through known techniques.

The television may be an in-room television. The display may be an in-room display. The in-room television or in-room display may be connected to the on-site local area network of the multi-room accommodation. The in-room television or in-room display may be connected to an additional on-site local area network of the multi-room accommodation. The in-room television or in-room display may be connected to a network configured to provide audio and video data.

The system may authenticate the in-room television or in-room display. The authentication may be initially performed during commissioning, for example by associating the unique identification with the in-room television or in-room display. In other embodiments, authentication may be performed by using stored data associated with the in-room television or in-room display, the stored data may be used to identify that the in-room television or in-room display is associated with the on-site local area network.

The on-site local area network of the multi-room accommodation may be connected to a wide area network such as the internet.

The on-site local area network may be a subnet.

The media streaming device discovery request may be communicated through a MDNS (Multicast Domain Name System) message. The MDNS message sent may be a known in the art, for example, guest devices wanting to connect to a Chromecast (RTM) will communicate a M-Search *HTTP/1.1 packet to the router.

Typically, a media streaming device on the same local area network, would communicate through MDNS, for example, a NOTIFY * HTTP/1.1 packet is sent to announce the IP address and port that it is listening to and the location of its device description XML file. Typically, an Simply Service Discovery Protocol (SSDP) and/or Discovery and Launch (DIAL) protocols are used for device discovery.

In some embodiments, the announced IP address in the notification packet may be modified. In some embodiments, the listening port in the notification packet may be modified.

In the current systems and methods, the media streaming device and guest device are not part of the same subnetwork so the typical device discovery will not work. Therefore, an intermediary i.e. the cloud server, virtual multi-room accommodation site container and multi-room accommodation router is provided. The intermediary provides a way to monitor and modify data packets to make the guest device and/or the media streaming device believe they are part of the same local area network, i.e. the same subnetwork. For example, the NOTIFY * HTTP/1.1 packet may be modified such that it makes the media streaming device appear to be on the same network.

A virtual media streaming device may be provided in the cloud server. A plurality or pool of virtual media streaming devices may be provided, wherein each virtual media streaming device may correspond to one media streaming device in the media streaming unit. That is to say that a virtual media streaming device corresponds to a physical media streaming device. It should be understood that the term virtual media streaming device does not mean a fully virtualise machine or fully virtualised media streaming device but rather is all the information and data required for the cloud server, preferably the virtual multi-room accommodation site container, to pretend to be the physical media streaming device for the purposes of communications but not for streaming. That is to say that the cloud server, preferably the virtual multi-room accommodation site container, acts as a media streaming device for establishing a connection and receiving communications.

The multi-room accommodation router may be configured to interact with the on-site local area network at a packet level. The multi-room accommodation router may comprise software to connect to the virtual multi-room accommodation site container.

The on-site local area network may be a wireless local area network.

The virtual multi-room accommodation site container may be configured to monitor packets from the on-site virtual container. The virtual multi-room accommodation site container may be configured to perform packet filtering and packet manipulation of the data packets of the on-site local area network routed by the multi-room accommodation router. In some embodiments, the packet filtering and packet manipulation improves the integration of the system since it can interact with on-site local area networks of varying configurations, as well as modify data packets to allow the guest device and media streaming device to establish a connection.

The system and method may be considered a way of providing a means for a media streaming device to be used by a guest device when both devices are on different subnetworks. The system and method provide a way of manipulating data packets by falsifying information and details so that the media streaming device appears as though it is connected to the same subnetwork as the guest device, i.e. it appears as connected to the on-site local area network.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a schematic representation of a hotel content streaming system according to the prior art;

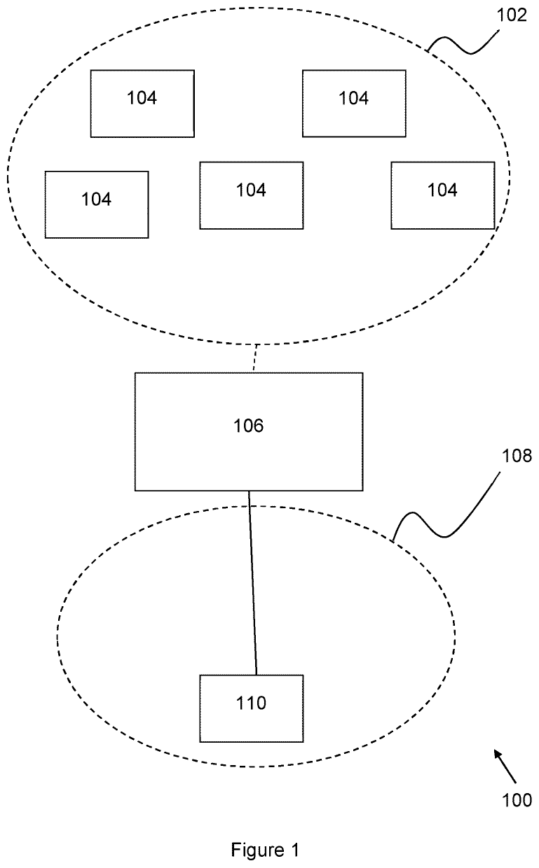

FIG. 2 shows a schematic representation of an embodiment according to the present invention; and

FIG. 3 shows a schematic representation of an embodiment according to the present invention.

### DESCRIPTION OF PREFERRED EMBODIMENTS

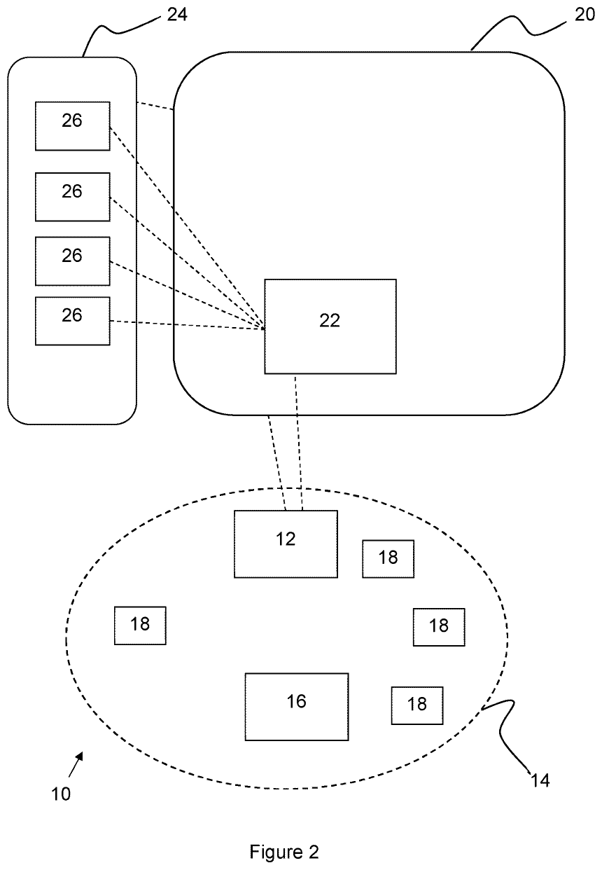

Referring to FIG. 2, a system for streaming audio and video content is generally indicated at 10. In the current example embodiment, the system 10 is described as used with a hotel, but it may be used with other multi-room establishments such as student accommodation.

A hotel router 12 is provided. The hotel router is connected to an on-site local area network (LAN) 14 at a hotel, preferably a wireless local area network, i.e. a wireless area network (WLAN) provided at the hotel premises. The on-site local area network 14 may be a High Speed Internet Access Local Area Network (HSIA LAN). A gateway 16, such as a router, is connected to the on-site LAN and provides access to a wide area network such as the internet.

Typically, a hotel guest will join the on-site local area network 14 with their guest device 18, such as a smart phone, tablet, laptop or similar, so as to have access to the hotel's network and the internet. This is achieved through a number of well-known means and implementations.

The hotel will have a number of guest rooms, each room being provided with a television (TV). The in-room TV is provided to the hotel guest for entertainment purposes. The TV will be connected to a network within the hotel, preferably a network which has excess to the internet, for example the on-site local area network 14. The TV will be configured to receive a stream of audio and video data.

A remote, i.e. off-site, cloud server 20 is provided. The cloud server may comprise a virtual server and/or pool manager in some embodiments to control and manage the functions described.

A virtual container 22 is provided for each hotel and communicatively connected to the hotel router 12. The virtual hotel site container 22 comprises lightweight software packages that comprises all dependencies to execute one or more software applications. The dependencies may include system libraries, code packages, and operating system level applications among other things.

A media streaming unit 24 is provided. The media streaming unit 24 is provided off-site, i.e. in a data centre, away from the hotel premises and may be operably configured to communicate with the cloud server 20 and/or the virtual hotel site container 22.

A plurality of media streaming devices 26 are provided and form a pool of media streaming devices. Each media streaming device 26 is connected to the media streaming unit 24 and housed within an enclosure of the media streaming unit 24.

The media streaming unit 24 is communicatively connected to the cloud server 20 and the virtual hotel site container 22. The media streaming unit 24 is configured to direct data and instructions between the or each media streaming device 26 and the cloud server 20 and/or the virtual hotel site container 22.

A virtual private network is established between the hotel router 12, the virtual hotel site container 22, cloud server 20, media streaming unit 24 and media streaming device 26.

The method of establishing a connection between a guest device, media streaming device and television will now be briefly described.

A hotel guest wishing to stream content, such as movies or other audio and video data, accesses the system 10 by using a unique identification code available within the hotel room. In the current embodiment, a quick read (QR) code is provided which includes a unique identification code and a security key. During commission of the system at the hotel, the QR code is associated with the specific TV in the room. The hotel guest uses their device 18 to scan the QR code which associates the device and TV with the system.

The cloud server 20 may initially determine which of the media streaming devices 26 in the pool are available for use. The initial determination may also be based on which media streaming devices are currently not in use or other factors such as which media streaming device will provide a low latency. The cloud server 20 may initially reserve one media streaming device 26 or a set of media streaming devices for potential use by the guest device 18.

The guest device 18 will initiate a connection request to a media streaming device 26, for example from pressing an icon on the display within an application running on the guest device. The guest device 18 will send out a MDNS data packet which contains the connection request.

The hotel router 12 monitors data packet transmission through the on-site LAN 14 for MDNS packets and connection requests. Upon receipt of the relevant data packet, the hotel router 12 will notify the cloud server 20, specifically the virtual hotel site container 22, of the connection request, for example, by forwarding the data packet containing the connection request.

In response to the connection request, a reply to the guest device 18 is communicated through the hotel router 12. In the current embodiment, the cloud server 20 and/or the virtual hotel site container 22 effectively pretends to be the or each media streaming device 26 in the pool and modify responses so that the or each media streaming devices appears to be connected to the same on-site LAN 14 as the guest device 18.

The authentic details and responses of the initially reserved one media streaming device 26 or the set of media streaming devices are used when responding to the connection request.

A cache of the relevant information and data for each media streaming device 26 within the pool is provided to effectively pretend to be on the same on-site LAN 14. In the current embodiment, the cache comprises authentic information and data from each media streaming device 26. In some embodiments, an authentic notification data packet from each media streaming device 26 may be stored and authentic device description details or the location of the device description details may be stored in the cache. The device description details or location of the device description details may be modified prior to transmitting to the guest device 18 ensure that the or media streaming device 26 will appear as though it is connected to the on-site LAN 14. The authentic notification data packet stored in the cache may be modified so to appear as if the or each media streaming device 26 is connected to the on-site LAN 14.

The cloud server 20, and/or the virtual container 22, modifies the response to the connection request so that when transmitted back through the hotel router 12 it appears to have come from the same subnet, effectively falsifying the network it is part of.

In some embodiments, the cloud server 20 and/or the virtual hotel site container 22, may effectively act as virtual media streaming devices, or in other embodiments virtual media streaming devices may be provided. The cloud server 20 and/or the virtual hotel site container 22 act as virtual media streaming devices in the sense that they may respond as if they are authentic media streaming devices. In essence, they are not fully virtualised media streaming devices since they may not stream audio and video data, however, they may communicate with the guest device 18 as if they are authentic media streaming devices 26 on the same subnet. The virtual cloud server and virtual container are to be understood in the usual sense to the person skilled in the art.

The authentic details and responses of the initially reserved one media streaming device 26 or the set of media streaming devices are used when responding to the connection request. The response is sent as if it was a reply for a media streaming device on the same subnet.

A connection is established between the guest device 18 and one of the media streaming device 26 through the virtual hotel site container 22 and/or the cloud server 20. The guest device and the media streaming device 26 are effectively paired together for the period of use. If a set of reserved media streaming devices is sent, the guest device may determine which it may establish a connection with.

The hotel guest controls the application running on their guest device 18 to start streaming content to the in-room television. Instructions are sent to the cloud server 20, more specifically the virtual hotel site container 22. Typically, these instructions will be sent through the on-site LAN 14 and intercepted by the hotel router 12.

In response to the received instructions, the cloud server 20 and/or virtual hotel site container 22 will pass through the instructions to the paired media streaming device 26. In some cases, the cloud server 20 and/or virtual hotel site container 22 will emulate the received instructions instead of passing them through.

The connected media streaming device 26 generates a stream of audio and video data. The data is encoded and transmitted to the identified in-room TV. The stream may be transmitted over a content distribution network (CDN). In some embodiments, it may be transmitted back through the cloud server 20 and the router 12. Various encoding and streaming processes are known in the art and could be readily used.

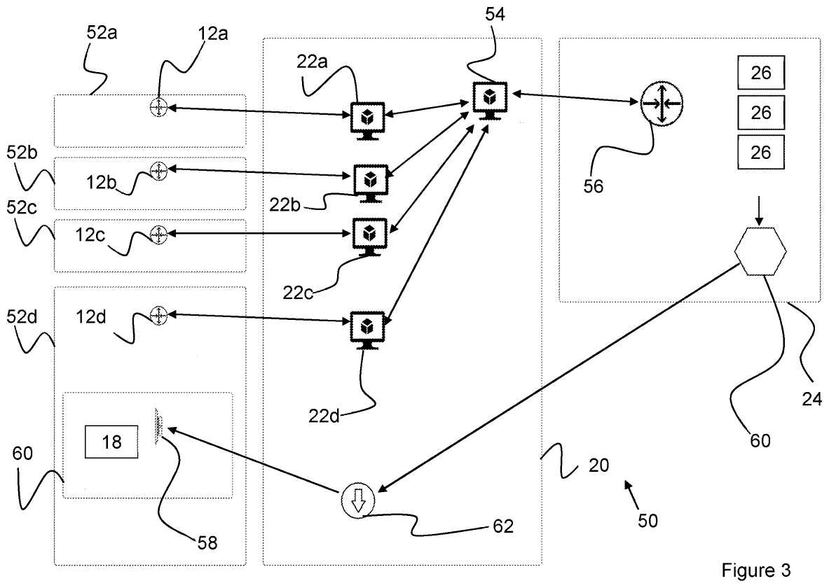

Referring to FIG. 3, a system streaming audio and video data is generally indicated at 50. The system 50 in FIG. 3 operates in the same fashion as that shown in FIG. 2 but is scaled so as to provide for a plurality of hotels which have a plurality of guest rooms with in-room TVs. The system in FIG. 3 is applicable to other multi-room accommodations.

In the embodiment shown in FIG. 3, there are four separate hotels 52a, 52b, 52c, 52d. Although not shown, each hotel 52a, 52b, 52c, 52d has an on-site local area network.

A hotel router 12a, 12b, 12c and 12d is provided for each hotel 52a, 52b, 52c, 52d and is part of the on-site local area network at said hotel.

Four virtual hotel site containers 22a, 22b, 22c, 22d are provided. Each virtual hotel site container 22a, 22b, 22c, 22d corresponds to a single hotel 52a, 52b, 52c, 52d and is connected to the respective hotel router 12a, 12b, 12c and 12d.

An off-site cloud server 20 disposed in a data centre remote to the hotels 52a, 52b, 52c, 52d is provided. The cloud server 20 hosts each of the four virtual hotel site containers 22a, 22b, 22c, 22d and a virtual pool server 54. The cloud server comprises a software defined network between the virtual containers 22a, 22b, 22c, 22d and the virtual pool server 54.

A media streaming unit 24 is off-site with respect to the hotel and disposed in a data centre. A plurality of media streaming devices 26 are provided with the media streaming unit 24. A streaming device router 56 is provided with the media streaming unit and connected to each media streaming device 26. The streaming device router 56 directs communications to the relevant media streaming device 26.

In the embodiment shown in FIG. 3, the method of connection between guest device 18, media streaming device 26 and television 58 within a room 60 is effectively the same as discussed above. With the exception that the virtual pool server 54 provides a link between the virtual hotel site containers 22a, 22b, 22c, 22d.

In a similar fashion to that described above, the media streaming device 26 encodes audio and video data through an encoder means 60 and streams said data through a content distribution network 62 to the identified TV 58.

The embodiments described above are especially advantageous as it requires one small hotel router per hotel and no additional wireless local area networks or specific in room technologies other than the existing in-room television. The remote cloud server offered orchestrates which media streaming devices (e.g. Chromecasts) are allocated to which guests, the same serves builds a per guest network dynamically over a secure VPN so that the guest device can communicate with the device. This reduces the equipment required at the hotel and will improve adoption since it can be integrated into the hotel more quickly.

Additionally, the embodiments ensure that the constraints of each hotel's network design are removed and the system abstracts this so that media streaming devices may be re-used over and over again. This is especially advantageous since the media streaming devices go unused when the hotel room is unoccupied, or the in-room television with connected media streaming device is not used.

Great benefit can also be found in the embodiments when used with a plurality of hotels, especially when each hotel in the plurality of hotels are in different time zones, since it is possible for one media streaming device to be used at different times by different hotels.

The embodiments described above are provided by way of example only, and various changes and modifications will be apparent to persons skilled in the art without departing from the scope of the present invention as defined by the appended claims.

What is claimed is:

1. A content streaming system for streaming audio and video data to a television within a multi-room accommodation, the system comprising:
a multi-room accommodation router being operably configured to connect to an on-site local area network at a multi-room accommodation, the multi-room accommodation router being configured to monitor, interact with and forward data packets on the local area network of said multi-room accommodation;
an identification code for disposal to the television in the multi-room accommodation, wherein the identification code comprises a unique ID and a security key for uniquely identifying the television in the multi-room accommodation to the system;
a media streaming unit disposed in a data centre that is off-site with respect to and away from the multi-room accommodation, the media streaming unit including a plurality of media streaming devices, each media streaming device being operable to encode and transmit audio and video data to the television within the multi-room accommodation; and
a cloud server disposed off-site with respect to the multi-room accommodation, the cloud server comprising a virtual multi-room accommodation site container communicatively connected to the multi-room accommodation router and to the media streaming unit, the cloud server being configured to receive a message containing the unique ID and the security key from a quest device and, in response, initially reserve one or more media streaming devices from the plurality of media streaming devices for use by the quest device;
wherein the system is configured to:
monitor data packets from the on-site local area network of said multi-room accommodation for media streaming device connection requests from a guest device connected to the on-site local area network of said multi-room accommodation;
communicate, in response to media streaming device connection request, a notification packet for the or each media streaming device from the cloud server to the guest device connected to the on-site local area network through the multi-room accommodation router, wherein the notification packet comprises at least some authentic device description details and at least some modified data configured to show that the or each media streaming device is connected to the on-site local area network of the multi-room accommodation;
establish connection between the guest device on the on-site local area network and one of the media streaming devices in the off-site media streaming unit through the cloud server;
receive instructions for the media streaming device from the guest device at the cloud server; and
generate a stream of audio and video data at the connected media streaming device based on the received instructions, and encode and transmit the audio and video data to the identified television in the multi-room accommodation for display at a television in the multi-room accommodation.

2. The content streaming system as claimed in claim 1, in which the virtual multi-room accommodation site container is configured to perform packet filtering of the data packets from the on-site local area network of said multi-room accommodation and packet manipulation of the data packets from the on-site local area network of said multi-room accommodation.

3. The content streaming system as claimed in claim 1, in which the system is further configured to emulate or passthrough the received instructions sent from the guest device to the media streaming device of the established connection.

4. The content streaming system as claimed in claim 1, comprising a plurality of multi-room accommodation routers, each multi-room accommodation router being operably configured to connect to an on-site local area network at one multi-room accommodation of a plurality of multi-room accommodations; wherein the cloud server comprises a plurality of virtual multi-room accommodation site containers, each virtual multi-room accommodation site container corresponding to one multi-room accommodation of the plurality of multi-room accommodations and being connected to the corresponding multi-room accommodation router.

5. The content streaming system as claimed in claim 4, in which each virtual multi-room accommodation site container has access to the media streaming unit.

6. The content streaming system as claimed in claim 1, in which the device description details for each media streaming device of the plurality of media streaming devices are stored in a cache of the cloud server.

7. The content streaming system as claimed in claim 1, in which a virtual private network is formed between the guest device, multi-room accommodation router, the cloud server and the media streaming unit.

8. (canceled)

9. (canceled)

10. The content streaming system as claimed in claim 1, in which the system is further configured to monitor usage statistics of the plurality of media streaming devices in the media streaming unit and optimise power consumption of the media streaming unit based on the monitored usage statistics.

11. The content streaming system as claimed in claim 1, in which the virtual multi-room accommodation site container comprises a stored multi-room accommodation configuration, wherein the stored multi-room accommodation configuration is loaded to the connected media streaming device during use at the multi-room accommodation and unloaded after use, wherein the multi-room accommodation configuration includes a user interface.

12. A method of streaming audio and video data to a television within a multi-room accommodation, the method comprising the steps of:
providing a pool of media streaming devices in an off-site location remote to the multi-room accommodation;
monitoring, by a multi-room accommodation router connected to an on-site local area network at the multi-room accommodation, data packets from an on-site local area network within said multi-room accommodation for a media streaming device connection request from a guest device connected to the on-site local area network;
providing an identification code for disposal to the television in the multi-room accommodation, wherein the identification code comprises a unique ID and a security key for uniquely identifying the television in the multi-room accommodation to the system;
communicating, in response to the media streaming device connection request, a notification packet for the or each media streaming device from an off-site cloud server connected to the pool of media streaming devices, the off-site cloud server comprises a virtual multi-room accommodation site container communicatively connected to the multi-room accommodation router and the pool of media streaming devices, wherein the notification packet comprises at least some authentic device description details and at least some modified data configured to show that the or each media streaming device is connected to the on-site local area network of the multi-room accommodation, the cloud server being configured to receive a message containing the unique ID and the security key from a guest device and, in response, initially reserve one or more media streaming devices from the plurality of media streaming devices for use by the guest device;
establishing a connection between the guest device and one of the media streaming devices in the pool of media streaming devices;
receiving instructions for the media streaming device from the guest device at the cloud server; and
generating a stream of audio and video data at the media streaming device based on the received instructions, and encoding and transmitting the audio and video data to the identified television in the multi-room accommodation for display at the television in the multi-room accommodation.

13. The method as claimed in claim 12, in which the virtual multi-room accommodation site container is configured to perform packet filtering of the data packets from the on-site local area network of said multi-room accommodation and packet manipulation of the data packets from the on-site local area network of said multi-room accommodation.

14. The method as claimed in claim 12, in which instructions for the media streaming device received by the virtual multi-room accommodation site container are emulated or passed through to the media streaming device of the established connection.

15. The method as claimed in claim 12, in which the device description details for each media streaming device are stored in a cache of the cloud server and are accessible by the virtual multi-room accommodation site container.
